(19) United States
(12) Patent Application Publication
(10) Pub. No.: US 2013/0021170 A1
(43) Pub. Date: Jan. 24, 2013

(54) TRAFFIC MONITORING DEVICE AND METHOD

(71) Applicant: LAWRENCE E. ANDERSON, ARLINGTON, VA (US)

(72) Inventor: LAWRENCE E. ANDERSON, ARLINGTON, VA (US)

(73) Assignee: LAWRENCE ANDERSON, ARLINGTON, VA (US)

(21) Appl. No.: 13/189,505

(22) Filed: Jul. 23, 2011

(51) Int. Cl. G08G 1/09

(52) U.S. Cl. 340/905

(57) ABSTRACT

A system for monitoring the flow of vehicular traffic comprising at least one first transmitter receiver that detects the passage of a vehicle; at least one second transmitter for transmitting the data relating to the passage of a vehicle at a predetermined point on a roadway for use by motorists in determining a route of travel. A method for monitoring the flow of vehicular traffic for purposes of determining a route of travel for motorists comprising determining traffic speed at at least one point along a roadway using at least one first transmitter receiver that detects the passage of a vehicle; transmitting the traffic speed using at least one second transmitter for use by motorists in determining whether or not to select passage along the roadway containing the at least one point as a way to navigate through the region.

### BACKGROUND OF THE INVENTION

It is known in the prior art to tune into a radio station for a periodic traffic report. However, a person is in his or her car about to enter a congested limited access highway, it is highly unlikely that a traffic broadcast will be occurring at that time.

For most commutes to and from work, people generally travel the same route every work day. However, whether their commute will be bumper to bumper traffic or a speedy ride home is largely unknown. When traffic slows to a stand still, energy is wasted as cars and trucks idle unnecessarily. In an age when energy consumption is a national concern, devices which promote traffic flow are in large demand.

### SUMMARY OF THE PRESENT INVENTION

The present invention is directed to monitoring of traffic using set radio frequencies for localized traffic reporting, Global Positioning Systems and/or traffic signs.

A preferred embodiment comprises a system for detecting the flow of traffic on highways using monitors and/or reports of fellow motorists. The monitors may be traffic cameras from which data is gathered by a person monitoring the display screen and relayed by voice over a predetermined radio frequency. Or the radio station may be composed of members of the public using the highway to enlighten others as to traffic tie-ups, accidents, and jams.

A preferred embodiment may comprise the apparatus associated with speed cameras or radar to monitor traffic flow. For example, radio station AM 650 may be devoted to the traffic reporting for a major highway, such as the north of the Beltway surrounding Washington D.C. Speed of traffic can be obtained via radar and relayed by electronic means, such as for example, speed at mile marker 20 is currently 50 MPH. In the case of an accident or obstruction, radio station AM 650 would report “accident in right lane; move to the left to get by.” The radar would report “traffic speed 40 MPH at mile marker 20” traffic speed 10 MPH at mile marker 30″ “traffic speed 50 MPH at mile marker 40.” Thus, one can then make the determination that there is likely an accident between mile marker 30 and mile marker 40. Using this information, one can make the decision to exit the highway at mile marker 20 and return at mile marker 40, thereby bypassing the slowed traffic. In addition, vocal message may be left by fellow motorist, local government employees or police personnel at AM 650. Using such a technique, the motorist will know the speed of the vehicular traffic before entering the highway so that an educated decision can be made whether or not to enter.

Moreover, since the information broadcasted from AM 650 is of a local nature, the radio broadcast may be from a local transmitter of limited range. When in the area of mile marker 20, the radio broadcast on AM 650 would be devoted to the area in the vicinity of mile markers 20 to 40. When in the area of mile markers 40 to 60, AM 650 would contain information relating to that area. Moreover, for easterly traffic, a given station may be used while for westerly traffic, AM 670 could be utilized.

A preferred embodiment comprises an interconnection with a GPS system. Depending upon the traffic flow, the GPS system could be set to route traffic to maximize time of travel. In a case involving the northern part of the beltway, for example, a route encompassing the northern part of the beltway may depend on the flow of traffic on the northern part. As an option, traffic speed could be monitored at street level and relayed to the satellites embodying the GPS system or to other satellites. The GPS system could then incorporate traffic speed when determining routing. As a further option, individual units in motorist's cars could integrate the vehicle speed data with GPS data to determine the motorist route of travel.

In one preferred embodiment traffic flow could be monitored using foot print type sensors to detect the front and back tires striking sensors. A lane could be reserved for cars only and passed upon the sensor imprint or actuation, speed of the car could be determined. That is, two sensors spaced a given distance apart could determine car speed or average car speed.

A preferred embodiment comprises a system for monitoring the flow of vehicular traffic comprising at least one first transmitter receiver that detects the passage of a vehicle; at least one second transmitter for transmitting the data relating to the passage of a vehicle at a predetermined point on a roadway for use by motorists in determining a route of travel. The system may comprise a plurality of first transmitter receivers spaced at intervals along a roadway for detecting the speed of a vehicles passing in the vicinity of the first transmitter receivers. The first transmitter receivers may be radar transmitter/receivers which are spaced apart at intervals along a highway or roadway, such as for example, every mile or within each section of a limited access highway, so that motorists may become aware of traffic conditions on the road ahead and exit the limited access highway based upon the information relayed at an exit preceding the point in the limited access highway. The information obtained by the radar transmitter/receivers may be relayed to motorists navigating in the nearby region.

In a preferred embodiment, optionally the transmitters may transmit the traffic and vehicle information to a GPS receiver so as to enable use of the traffic information in conjunction with a GPS device. The GPS receiver may then determine the optimum suggested route for navigation based upon the average traffic speeds at the recorded points on a roadway or roadways. In addition or in the alternative, the transmitter may transmit (or broadcast) the vehicle speed information and traffic flow data at a radio frequency for reception by a motorist in the vicinity of the second transmitter. To accommodate many such stations on a limited frequency band, the signal strength of the radio transmission may be selected to be localized so that reception is limited to motorists traveling in the local region. Accordingly, the same frequency could be used at different locations.

An additional option is to operative connect the transmitter to a display for displaying traffic speeds at points along a roadway.

A preferred embodiment may further comprise a first processor operatively connected to the transmitter receivers such that the first processor operates to determine an average speed for vehicles at a predetermined point in the roadway. The first processor may be operatively associated with a second transmitter that transmits average speed data to one or more of GPS device, a radio broadcaster system, and/or a display for vehicles positioned along the same highway at a position prior to the predetermined point so that a vehicle approaching the predetermined point on the given roadway will have an option to take an alternate route depending upon the data reported. The second transmitter may transmit to a second receiver which is located at a point remote from the predetermined point and wherein the second receiver is operatively connected to a second processor which determines average traffic speed at intervals along a roadway, the second processor being operatively connected to one of a GPS system, radio transmission, or display in the vicinity of the roadway having the predetermined point thereon.

A preferred methodology comprises a method for monitoring the flow of vehicular traffic for purposes of determining a route of travel for motorists comprising determining traffic speed at at least one point along a roadway using at least one first transmitter receiver that detects the passage of a vehicle; and transmitting the traffic speed using at least one second transmitter for use by motorists in determining whether or not to select passage along the roadway containing the at least one point as a way to navigate through the region.

### BRIEF DESCRIPTION OF THE DRAWINGS

These and/or other aspects and advantages of the invention will become apparent and more readily appreciated from the following description of the embodiments, taken in conjunction with the accompanying drawings of which: The drawings of this invention are illustrative and diagrammatic in nature in order to present the principles of the invention. They are being provided as examples without limiting the invention to the specific configuration or dimensions shown.

FIG. 1A is a schematic illustration of a preferred embodiment traffic monitoring system comprising an overhead transmitter and ground based sensor or reflector.

FIG. 1B is a schematic illustration of an alternate preferred embodiment traffic monitoring system comprising a combined overhead transmitter and sensor 11R/T.

FIG. 1C is a schematic illustration from an overhead view of a preferred embodiment traffic monitoring system comprising an array of overhead receiver/transmitters 11.

FIG. 2 is a schematic illustration of the preferred embodiment of FIG. 1 taken along the lines 2-2 of FIG. 1.

FIG. 3 is a schematic illustration of an alternate preferred embodiment comprising ground based sensors 12A with roll-over detector strips 12B.

FIG. 4 is a schematic illustration of a preferred embodiment electrical circuitry diagram wherein the sensors 12 are electrically connected to a processor 13.

FIG. 5 is a schematic illustration a plurality of traffic monitoring devices 10 operatively connected to a receiver 14 and processor 15 for display 16, GPS trip calculation 17 and/or radio 18.

FIG. 6 is a schematic illustration of a plurality of traffic monitoring devices 10 using radar transmitters/receivers operatively connected to a receiver 14 and processor 15 for display 16, GPS trip calculation 17 and/or radio 18.

FIG. 7 is an illustration of an example of a GPS trip calculation scenario.

FIG. 8 is another illustration of an example of a GPS trip calculation scenario.

FIG. 9 is an illustration diagramming and/or outlining an example of a radio announcement for a scenario involving traffic on an arbitrarily selected route I-495.

FIG. 10 is an illustration depicting a map of an example of a corridor in which alternate routes are available, including two limited access highways.

FIG. 11 is an illustration of a GPS trip calculation scenario for the area depicted in the map illustration of FIG. 10.

FIG. 12 is an illustration of a diagram of a radio announcement sequence for the area depicted in the map illustration of FIG. 10.

FIG. 13 is an illustration of the mapped area of FIG. 10 showing possible placement of traffic monitoring devices D/T 10, which may be the systems of FIG. 1, FIG. 2, FIG. 3, FIG. 4, FIG. 5, and/or FIG. 6.

FIG. 14 is an illustration depicting the sequencing of transmissions from the devices D/T 10 of FIG. 13.

### DETAILED DESCRIPTION OF PREFERRED EMBODIMENTS

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout the description of the figures.

It will be understood that when an element is referred to as being “on” another element, it can be directly on the other element or intervening elements may be present. In contrast, when an element is referred to as being “directly on” another element, there are no intervening elements present. It will be understood that when an element is referred to as being “connected” or “coupled” to another element, it can be directly connected or coupled to the other element or intervening elements may be present. In contrast, when an element is referred to as being “directly connected or coupled” to another element, there are no intervening elements present. Furthermore, “connected” or “coupled” as used herein may include wirelessly connected or coupled. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first layer could be termed a second layer, and, similarly, a second layer could be termed a first layer without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” “left” or right” may be used herein to describe one element's relationship to other elements as illustrated in the Figures. It will be understood that relative terms are intended to encompass different orientations of the device in addition to the orientation depicted in the Figures. For example, if the device in one of the figures were turned over, elements described as being on the “lower” side of other elements would then be oriented on “upper” sides of the other elements. The exemplary term “lower”, can therefore, encompass both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

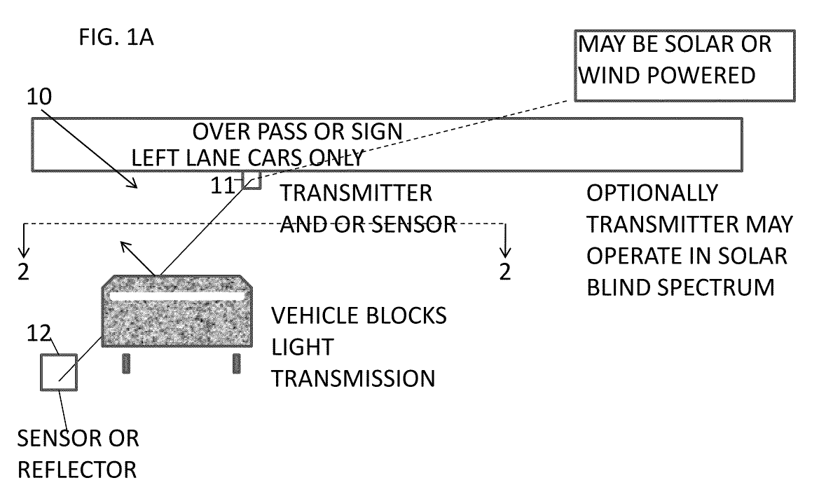

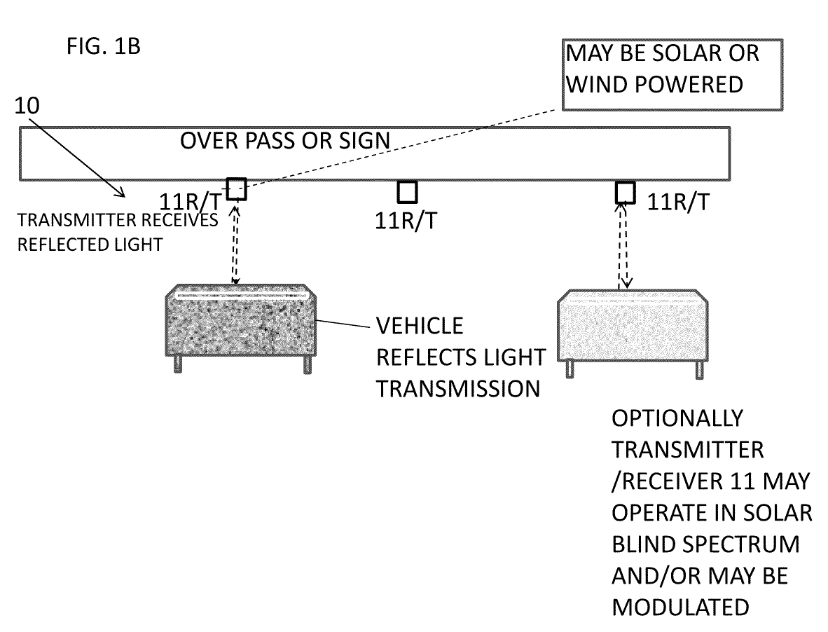

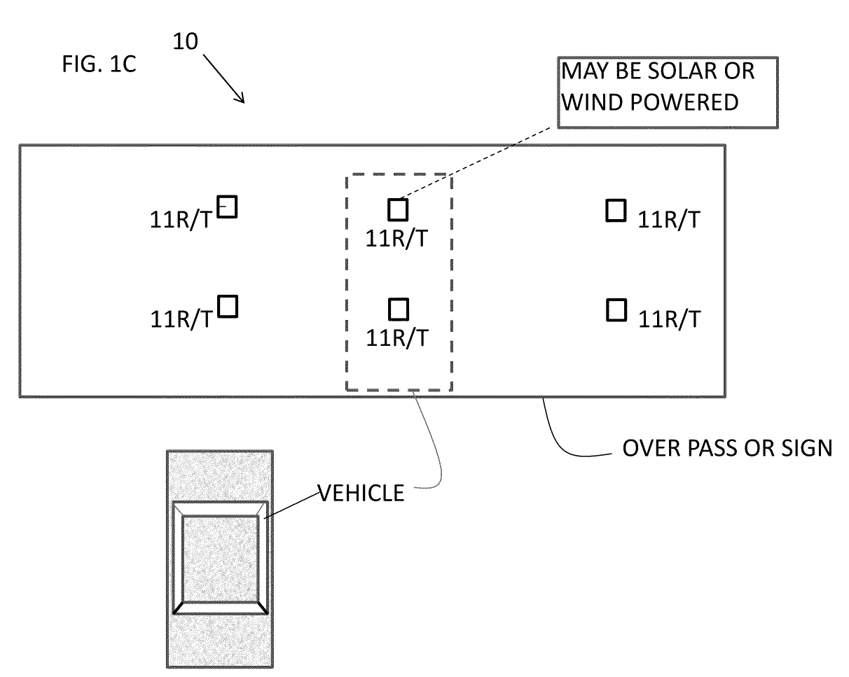

FIG. 1A is a schematic illustration of a preferred embodiment traffic monitoring system comprising an overhead transmitter and ground based sensor or reflector. The transmitter 11 may comprise an electromagnetic wave transmitter which transmits waves which are blocked or intercepted by a vehicle as the vehicle passes nearby as shown in FIG. 1A. The transmitter 11 may comprise a laser which operates in the solar blind region to avoid interference or confusion with sunlight. The transmitted waves emitted from transmitter 11 may also be modulated so as to be distinguishable from other sources of radiated electromagnetic waves. The reception (or lack of reception by sensor or reflector 12 will indicate the passage of a vehicle. The traffic lane may be designated cars only so that the measured vehicles are limited to cars. Given that cars do not vary greatly in length, a somewhat accurate speed assessment may be obtained. The sensed data may to averaged so that an approximate portrayal of traffic speed is obtained. The sensor 12 may be a photodetector or may reflect light back to the transmitter 11. The sensors may be mounted at ground level along the highway. Alternately, the element 12 may comprise a reflector mounted in the pavement surface. This would facilitate pavement resurfacing as new reflectors could be repositioned after pavement resurfacing. The transmitters may be positioned in a variety of ways including mounted to overpasses on the interstate, light poles or signs. Alternatively, the transmitters 11 could be mounted at ground level and the sensors 12 could be mounted to the signs, over passes or light poles. In order to obtain power for the electromagnetic transmitters 11, solar or wind power could be used. A solar panel could be positioned nearby or a wind turbine could be used to supply electric power. This makes the devices 10 independent of the need to connect them to the local grid and facilitates location and relocation of the devices to adapt to situational requirements. For example, if a highway is restructured, the devices 10 could be dismounted and remounted in a new location without the necessity of disconnection and reconnection to the local electrical grid. This is especially desirable when there is no electrical wiring or 4 source nearby.

Inasmuch as it would be undesirable to detect sunlight, the detector could be limited to light in the solar blind spectrum or could be modulated to distinguish the detected light from surrounding sources of electromagnetic radiation.

FIG. 1B is a schematic illustration of an alternate preferred embodiment traffic monitoring system comprising a combined overhead transmitter and sensor 11R/T. The electromagnetic radiation emitted from the transmitter receiver 11R/T is reflected by the surface of the vehicle into the transmitter receiver 11R/T. The radiation emitted from transmitter receiver 11R/T may be such that is not reflected by the pavement beneath the car. Alternately, a metal detector may be used, or radar which detects the presence of metallic elements. As shown in FIG. 1B, for multiple lanes, each lane may have a transmitter receiver 11R/T. Optionally, the vehicle speeds for each lane may be averaged and the traffic flow may be totaled. A combination of the devices 11 may be utilized inasmuch as the middle lane may rely on a reflective device as shown in FIG. 1B while the inner and outer lanes may utilize detectors as shown in FIG. 1A. Once again the transmission of electromagnetic radiation may be in the solar blind region to distinguish it from solar radiation. The electric power for system operation may come from a solar or wind power source or may be battery powered or connected to the electrical grid.

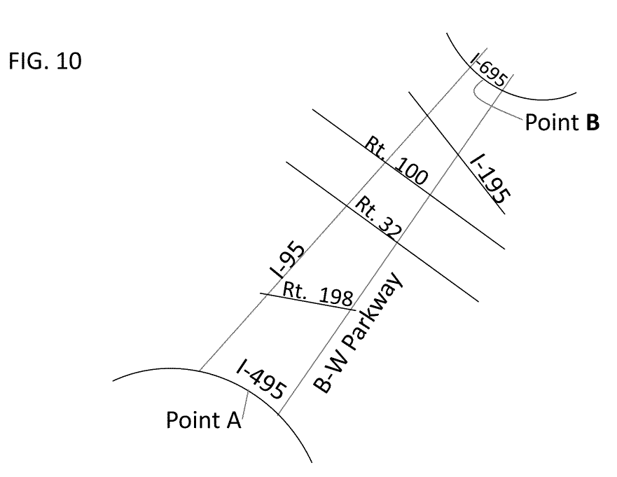

FIG. 1C is a schematic illustration from an overhead view point of a preferred embodiment traffic monitoring system comprising an array of overhead receiver/transmitters 11. The array may be the transmitters of FIG. 1A or FIG. 1B as each is compatible for operation with the arrangement depicted in FIG. 10. As seen in FIG. 10 as vehicle shown by dotted lines in beneath the array in the middle lane while a vehicle is approaching in the left lane. The array may be mounted to an overpass, bridge, walkway, sign or light pole. Alternately, a structure may be used exclusively for the positioning of the transmitters 11R/T through a structure constructed similar to an overhead sign structure. In the case of radar, a radar transmitter and/or receiver may be positioned at the side of the roadway.

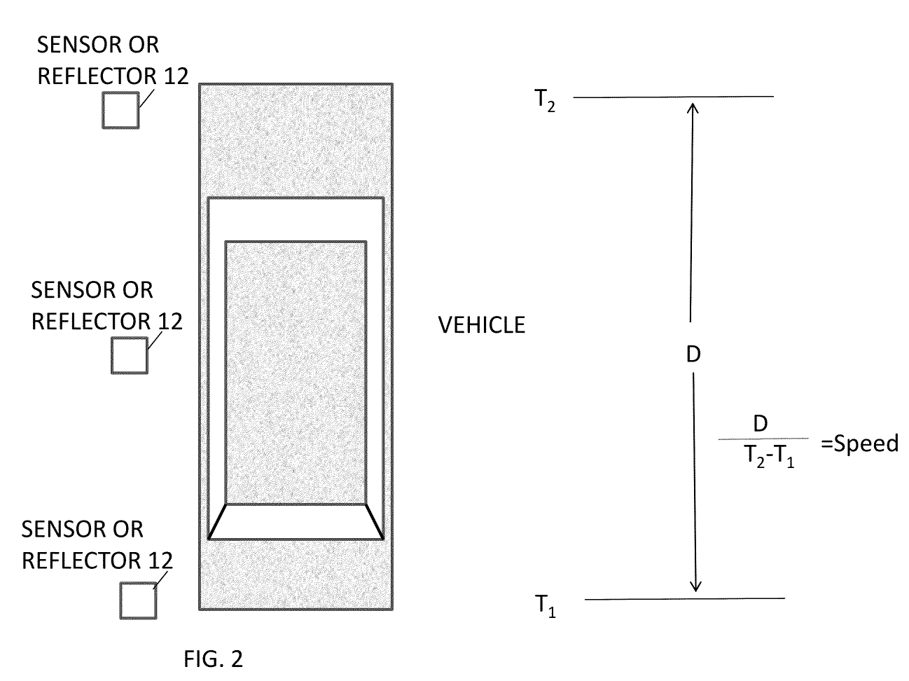

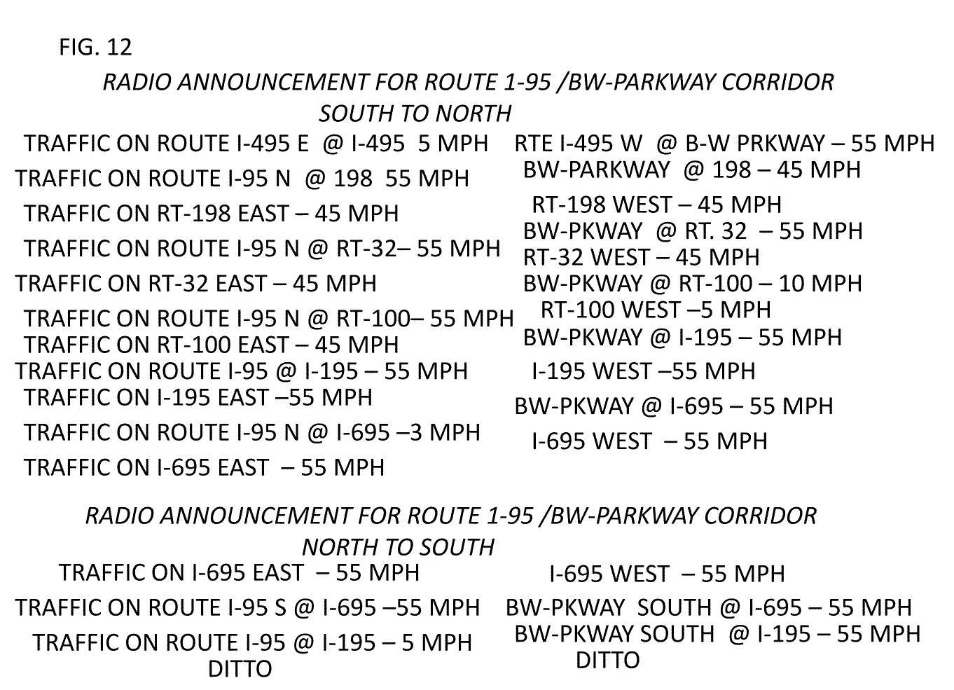

FIG. 2 is a schematic illustration of the preferred embodiment of FIG. 1A taken along the lines 2-2 of FIG. 1. Although three sensors/reflectors 12 are shown, two, four or more may work. As the front of the vehicle passes the first sensor 12 (lowermost in FIG. 12) the time is recorded (T₁). The middle sensor 12 may be used to show continuity, that is when the topmost sensor detects the presence of the vehicle, detection by the middle sensor assures that there is a single car involved and not detection of two vehicles with a space therebetween. As the front of the vehicle passes the uppermost sensor (as depicted in FIG. 2) the time is recorded (T₂). Knowing the distance between the sensors (upper and lower as depicted in FIG. 2, the distance traveled between the two instances in time (T₂−T₁) can be used to determine the speed. One the determination is recorded, it can be averaged with other readings to determine an average for the traffic. The recording can also be used to record the traffic flow, that is, each time one vehicle passes the electromagnetic radiation is blocked by the vehicle followed by a time interval in which the electromagnetic radiation is not blocked. Each such sequence (blocked followed by unblocked) represents the passage of a vehicle. Upon detecting vehicles over a period of time, such as one minute, the traffic flow per minute can be determined. Moreover, the traffic flow number is sensitive to recent stoppages or obstructions of traffic. For example if in the previous mile, two of the three lanes were obstructed, the speed of the traffic at this point would logically resume whereas the volume of traffic may be light due to the previous obstruction inhibiting the flow of traffic. If the traffic flow at a previous monitoring point was 60 cars per minute and the traffic flow is only five cars per minute as the present juncture, one might suspect an obstruction of traffic in the intermediate section of the roadway which would be cause for avoiding travel on that section.

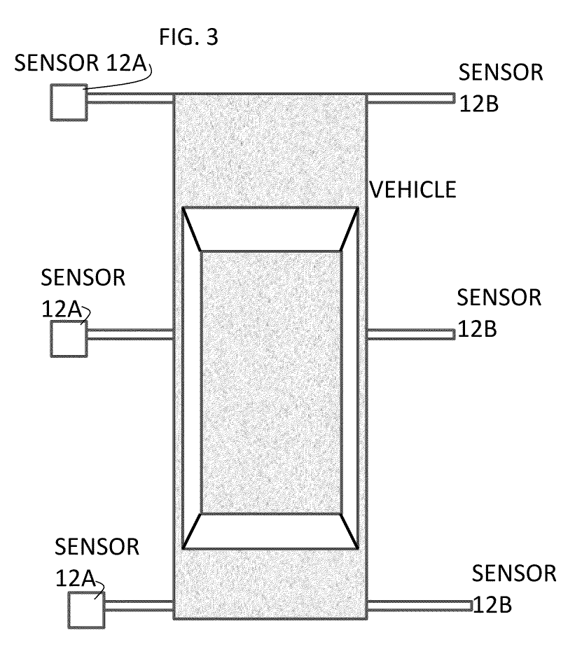

FIG. 3 is a schematic illustration of an alternate preferred embodiment comprising ground based sensors 12A with roll-over detector strips 12B. Although three strips are shown, two may be used; or an unlimited plurality such as, for example 4. The strips 12B may be compressible hose which record a signal as the vehicle tires compress the hose or tubing. Alternately the sections 12B may be metallic contact strips which complete an electrical circuit as a car's tires pass over the metal contacts. The detection of vehicle is substantially the same as the front of the vehicle passes the lowermost strip the time is recorded (T₁). The middle sensor 12 may be used to show continuity, that is when the topmost sensor detects the presence of the vehicle, detection by the middle sensor assures that there is a single car involved and not detection of two vehicles with a space therebetween. As the front tire of the vehicle passes the uppermost sensor (as depicted in FIG. 3) the time is recorded (T₂). Knowing the distance between the sensors (upper and lower as depicted in FIG. 2, the distance traveled between the two instances in time (T₂−T₁) can be used to determine the speed. Once the determination is recorded, it can be averaged with other readings to determine an average for the traffic. The recording can also be used to record the traffic flow, that is, each time a vehicle passes over the detector strip, a recording is made.

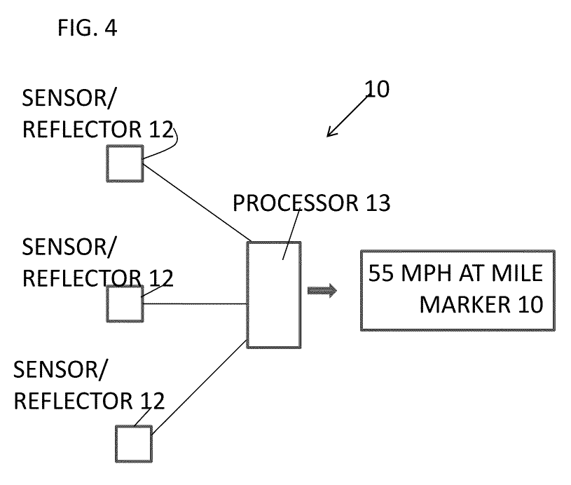

FIG. 4 is a schematic illustration of a preferred embodiment electrical circuitry diagram wherein the sensors 12 are electrically connected to a processor 13. The electric connection may be by wire or radio (wireless) type connection. The processor 13 is used to record signals indicating presence or passage of a vehicle and the speed may or may not be recorded at this point. If the speed is calculated, the processor in conjunction with a transmitter may emit a radio signal indicative of vehicular speed, such as “55 MPH” at the location of the traffic monitoring device 10.

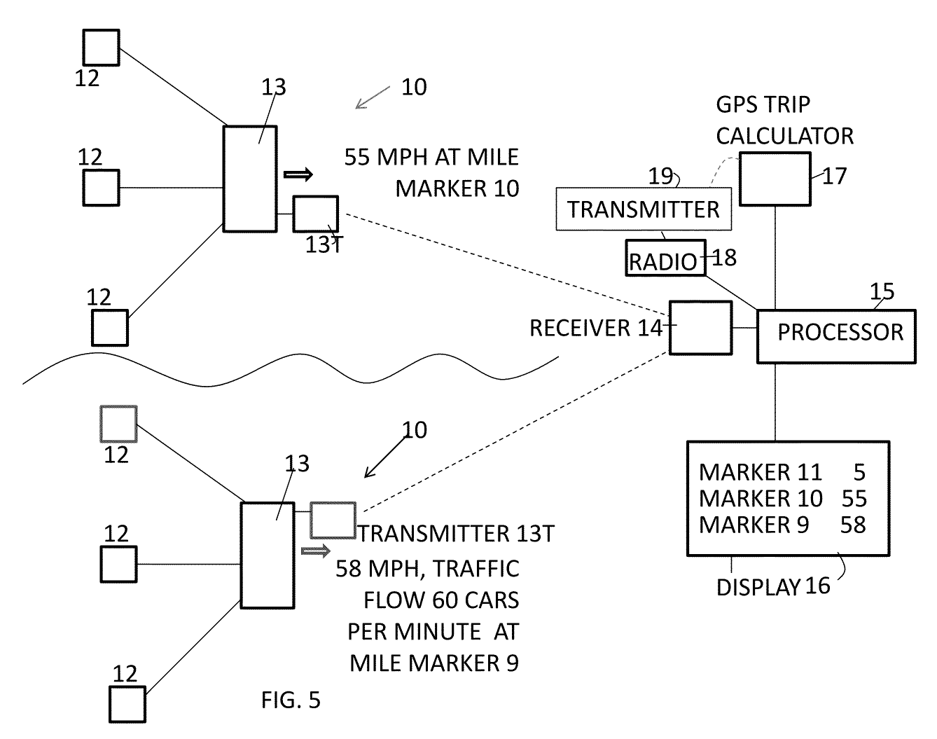

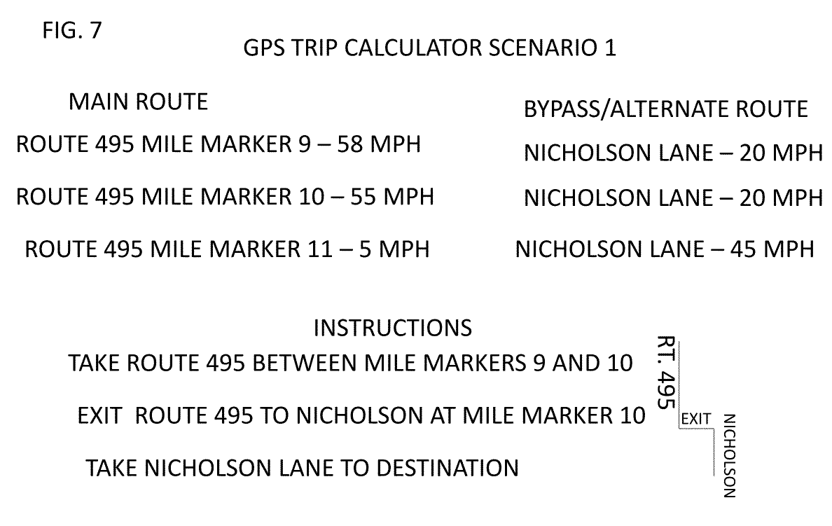

FIG. 5 is a schematic illustration a plurality of traffic monitoring devices 10 operatively connected to a receiver 14 and processor 15 for display 16, GPS trip calculation 17 and/or radio 18. Each traffic monitoring system 10 comprises one or more transmitters 11, and sensors or reflectors 12. Note that if only one transmitter is used signals can be transmitted to sensors/reflectors 12 from one central location or a plurality of spaced apart transmitters 11 may be utilized, such as for example, one of which is depicted in FIG. 1. The detected signal may be combined at a processor, combiner, or controller 13. The processor, combiner or controller 13 may have associated therewith a transmitter 13T which transmits a radio signal. The radio signal may be a time signal such as “traffic is flowing at 55 MPH at location X.” This signal may be directly received by a vehicle radio receiving the transmitted signal. Or the signal may be such that a GPS device, such as a Magellan® or Garmin®, may detect the signal for further processing as shown in FIG. 7, 8, or 11, for example. In the alternative, the transmitter 13T may send a signal to a remote receiver 14 operatively connected to a processor 15 which may compute the average speed and/or traffic flow at the location of the traffic monitoring device(s) 10. The signals may be combined for display on a highway sign 16 which may be positioned at the entrance of a limited access highway or along the limited access highway so that a driver may, for example, exit at mile marker 10 if the traffic at mile marker 11 is only 5 MPH. The processor or controller 15 may be operatively connected to a GPS trip calculator 17 (such as a Magellan® or Garmin® in a motorist's car) which can in turn process the signal to reroute traffic depending on traffic flow and/or speed. In addition, the processor 15 may be operatively connected to a radio transmitter combination 18, 19 which transmits locally over a frequency for reception by a motorist on the radio of the motorist's car. In the alternative, the receiver may be directly connected to a radio transmitter 19 so as to effectively broadcast the traffic speed and/or the traffic flow volume over the radio network for reception by a motorist's radio. The transmission by the transmitter may be used by the GPS device so that calculations will be made on the motorist's GPS device (e.g., a Magellan® or Garmin®) located in the motorist's car. In conjunction with the system depicted in FIG. 5, the sensors could be the rollover sensors of FIG. 3, or any other sensor disclosed herein.

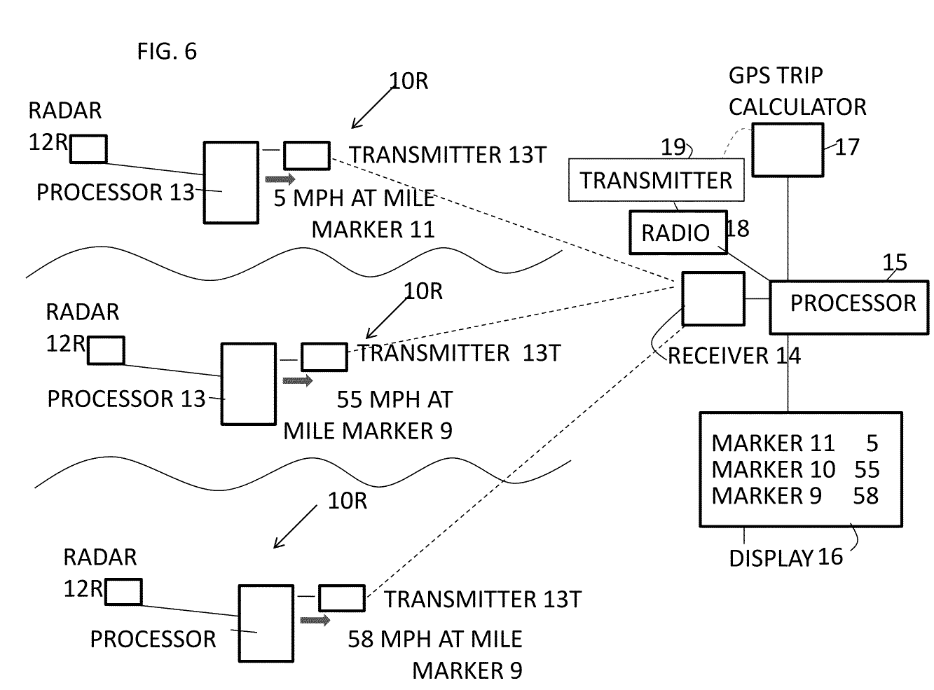

FIG. 6 is a schematic illustration of a plurality of traffic monitoring devices 10 using radar transmitters/receivers operatively connected to a receiver 14 and processor 15 for display 16, GPS trip calculation 17 and/or radio 18. Radar elements 12R detect vehicles as they pass by. Vehicular speed is relayed or transmitted by transmitters 13T, which transmits a radio signal. The radio signal may be a time signal such as “traffic is flowing at 55 MPH at location X.” This signal may be directly received by a vehicle radio receiving the transmitted signal. Or the signal may be such that a GPS device, such as a Magellan® or Garmin®, may detect the signal for further processing as shown in FIG. 7, 8, or 11, for example. In the alternative, the transmitter 13T may send a signal to a remote or nearby receiver 14 operatively connected to a processor 15 which may compute the average speed and/or traffic flow at the location of the traffic monitoring device(s) 10R. The signals may be combined for display on a highway sign 16 which may be positioned at the entrance of a limited access highway or along the limited access highway so that a driver may, for example, exit at mile marker 10 if the traffic at mile marker 11 is only 5 MPH. The processor or controller 15 may be operatively connected to a GPS trip calculator 17 (such as a Magellan® or Garmin® in a motorist's car) which can in turn process the signal to reroute traffic depending on traffic flow and/or speed. In addition, the processor 15 may be operatively connected to a radio transmitter combination 18, 19 which transmits locally over a frequency for reception by a motorist on the radio of the motorist's car. In the alternative, the receiver may be directly connected to a radio transmitter 19 so as to effectively broadcast the traffic speed and/or the traffic flow volume over the radio network for reception by a motorist's radio. The transmission by the transmitter may be used by the GPS device so that calculations will be made on the motorist's GPS device (e.g., a Magellan® or Garmin®) located in the motorist's car. In conjunction with the system depicted in FIG. 6, the sensors could be the rollover sensors of FIG. 3, or any other sensor disclosed herein.

FIG. 7 is an illustration of an example of a GPS trip calculation scenario. As shown in the table below.

GPS TRIP CALCULATOR SCENARIO 1

| MAIN ROUTE | BYPASS/ALTERNATE ROUTE |
|---|---|
| Rte. 495 Mile Marker 9 -58 MPH | Nicholson Lane at corresponding |
| | stretch 20 MPH |
| Rte. 495 Mile Marker 10 55 MPH | Nicholson Lane at corresponding |
| | stretch 20 MPH |
| Rte. 495 Mile Marker 11 5 MPH | Nicholson Lane at corresponding |
| | stretch 45 MPH |

The resulting traffic instructions may be as follows:

TAKE ROUTE 495 BETWEEN MILE MARKERS 9 AND 10
EXIT ROUTE 495 TO NICHOLSON AT MILE MARKER 10
   TAKE NICHOLSON LANE TO DESTINATION

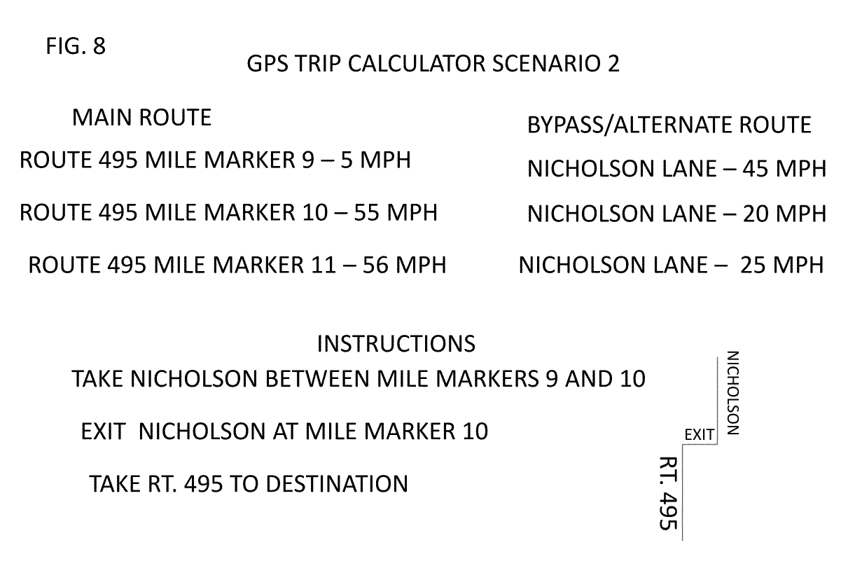

FIG. 8 is another illustration of an example of a GPS trip calculation; scenario 2, as shown in the following table:

GPS TRIP CALCULATOR SCENARIO 3

| MAIN ROUTE | BYPASS/ALTERNATE ROUTE |
|---|---|
| Rte. 495 Mile Marker 9 -5 MPH | Nicholson Lane at corresponding |
| | stretch 45 MPH |
| Rte. 495 Mile Marker 10 55 MPH | Nicholson Lane at corresponding |
| | stretch 20 MPH |
| Rte. 495 Mile Marker 11 56 MPH | Nicholson Lane at corresponding |
| | stretch 25 MPH |

The resulting traffic instructions may be as follows:

Take Nicholson Lane between Mile Markers 9 and 10, exit Nicholson Lane at Mile Marker 10 and take Route 495 to destination. The above scenarios are fictions and are merely intended to describe or depict examples of scenarios which may be adaptable to multiple road conditions and roads throughout the world. The idea being that as traffic flow varies, traffic may be expeditiously rerouted to save energy costs and motorists time.

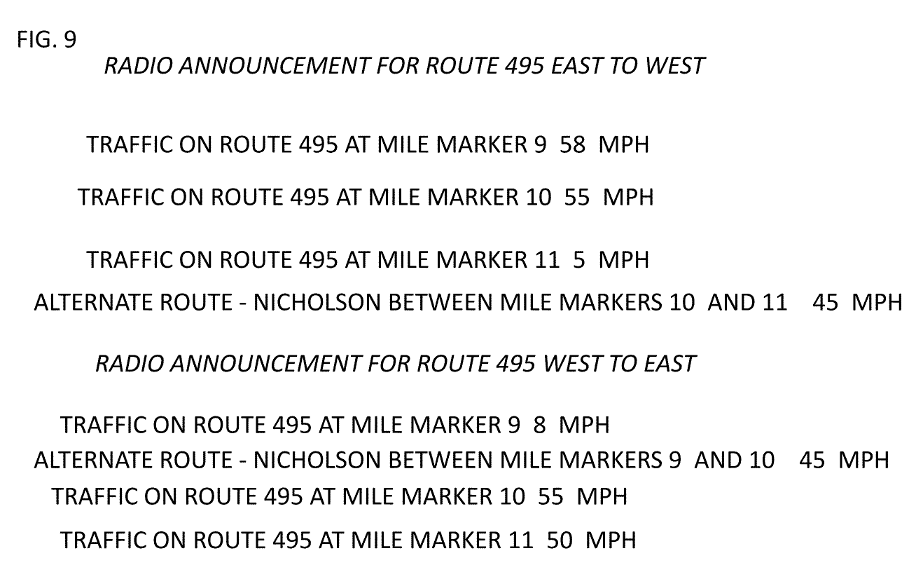

FIG. 9 is a illustration diagramming and/or outlining an example of a radio announcement for a scenario involving traffic on a arbitrarily selected route I-495, as shown in the following table.

Radio Announcement for Route 495 East to West

Traffic on Rte. 495 Mile Marker 9 -58 MPH; traffic flow 105 cars per
minute
Traffic on Rte. 495 Mile Marker 10 55 MPH; traffic flow 100 cars per
minute
Traffic on Rte. 495 Mile Marker 11 5 MPH; traffic flow 5 cars per minute

An automatic computer generated message and/or resulting traffic instructions may be as follows: For traffic east to west on Rte 495, exit at or near Mile Marker 10 to avoid traffic slow down at Mile Marker 11.

FIG. 10 is an illustration depicting a map of an example of a corridor in which alternate routes are available, including two limited access highways. As an example, the map approximates an area between the cities of Baltimore and Washington and in particular Interstate I-95 and the Baltimore Washington Parkway. Since I-95 has more lanes, it is the preferred route. Both routes are limited access routes where traffic may become ensnarled between exits. Signs posted along the highways could alert the motorists to the then current conditions in the roadway ahead to allow consideration of an alternate route. Such an alternate route choice for the thousands of cars using this corridor every day would result in more efficient energy usage, savings of energy costs and motorists time. The scenario depicted by the map in FIG. 10 envisions a trip from point A near the Route 495 Beltway encircling Washington D.C. to a point B near the Route 695 Beltway encircling Baltimore Md. The points and routes are merely exemplary to show the benefits of using a preferred embodiment of the invention.

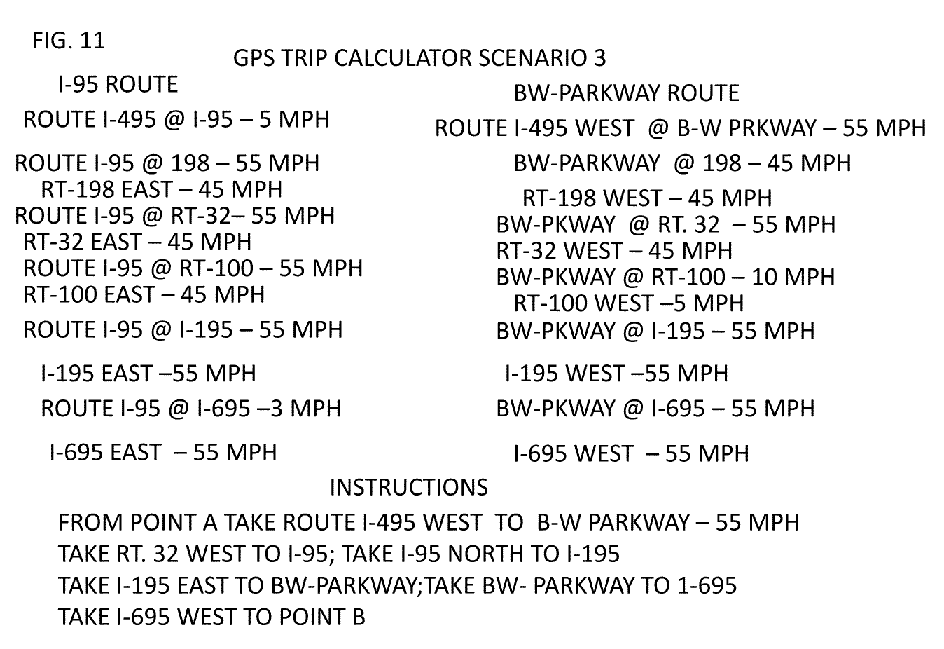

FIG. 11 is an illustration of a GPS trip calculation scenario for the area depicted in the map illustration of FIG. 10; scenario 5, as shown in the following table:

GPS TRIP CALCULATOR SCENARIO 3

| MAIN ROUTE | BYPASS/ALTERNATE ROUTE |
|---|---|
| Rte. 495 East @ I-95 -5 MPH | Rte I-495 West @ B-W Parkway - |
| | 55 MPH |
| Rte. I-95 @ Route 198 55 MPH | B-W Parkway @ 198 45 MPH |
| Route 198 east - 45 MPH | Route 198 west - 45 MPH |
| Rte. I-95 @ Route 100 55 MPH | B-W Parkway @ Rte. 100 10 MPH |
| Route 100 east - 45 MPH | Route 100 west - 5 MPH |
| Rte. I-95 @ Route I-195 55 MPH | B-W Parkway @ Rte. I-195 55 MPH |
| Route I-195 east - 55 MPH | Route I-195 west - 55 MPH |
| Rte. I-95 @ Route I-695 3 MPH | B-W Parkway @ Rte. I-695 55 MPH |

### Instructions:

From point A take Route F495 West to B-W Parkway (55 MPH). Take Route 32 West to I-95, Take I-95 North to I-195, Take I-195 East to B-W Parkway, Take BW Parkway to I-695 West to point B.

Using the above, the near stoppages of traffic on I-495 East and on I-95 at I-695 are avoided; avoiding costly delayed and increased energy costs. The above scenarios are fictions and are merely intended to describe or depict examples of scenarios which may be adaptable to multiple road conditions and roads throughout the world. The idea being that as traffic flow varies, traffic may be expeditiously rerouted to save energy costs and motorists time.

FIG. 12 is an illustration of a diagram of a radio announcement sequence for the area depicted in the map illustration of FIG. 10, as shown in the following table.

RADIO ANNOUNCEMENT FOR ROUTE 1-95/
BW-PARKWAY CORRIDOR SOUTH TO NORTH

| | |
|---|---|
| TRAFFIC ON ROUTE I-495 E @ | RTE I-495 W @ B-W PRKWAY - |
| I-495 5 MPH | 55 MPH |
| TRAFFIC ON ROUTE I-95 N @ | BW-PARKWAY @ 198 - 45 MPH |
| 198 55 MPH | |
| TRAFFIC ON RT-198 EAST - | RT-198 WEST - 45 MPH |
| 45 MPH | |
| TRAFFIC ON ROUTE I-95 N @ | BW-PKWAY @ RT. 32 - 55 MPH |
| RT-32 - 55 MPH | |
| TRAFFIC ON RT-32 EAST - | RT-32 WEST - 45 MPH |
| 45 MPH | |
| TRAFFIC ON ROUTE I-95 N @ | BW-PKWAY @ RT-100 - 10 MPH |
| RT-100 - 55 MPH | |
| TRAFFIC ON RT-100 EAST - | RT-100 WEST -5 MPH |
| 45 MPH | |
| TRAFFIC ON ROUTE I-95 @ | BW-PKWAY @ I-195 - 55 MPH |
| I-195 - 55 MPH | |
| TRAFFIC ON I-195 EAST - | I-195 WEST -55 MPH |
| 55 MPH | |
| TRAFFIC ON ROUTE I-95 N @ | BW-PKWAY @ I-695 - 55 MPH |
| I-695 - 3 MPH | |
| TRAFFIC ON I-695 EAST - | I-695 WEST - 55 MPH |
| 55 MPH | |

RADIO ANNOUNCEMENT FOR ROUTE 1-95/
BW-PARKWAY CORRIDOR NORTH TO SOUTH

| | |
|---|---|
| TRAFFIC ON I-695 EAST - | I-695 WEST - 55 MPH |
| 55 MPH | |
| TRAFFIC ON ROUTE I-95 S @ | BW-PKWAY SOUTH @ I-695 - |
| I-695 - 55 MPH | 55 MPH |
| TRAFFIC ON ROUTE I-95 @ | BW-PKWAY SOUTH @ I-195 - |
| I-195 - 5 MPH | 55 MPH |
| TRAFFIC ON ROUTE I-95 @ | BW-PKWAY SOUTH @ I-195 - |
| I-195 - 5 MPH | 55 MPH |

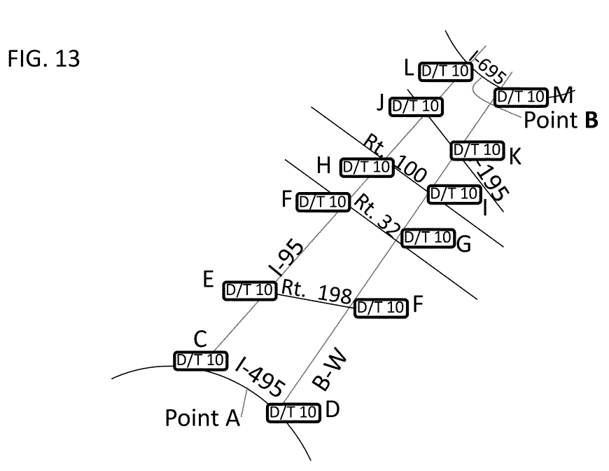

FIG. 13 is an illustration of the mapped area of FIG. 10 showing possible placement of traffic monitoring devices D/T 10, which may be the systems of FIG. 1, FIG. 2, FIG. 3, FIG. 4, FIG. 5, and/or FIG. 6.

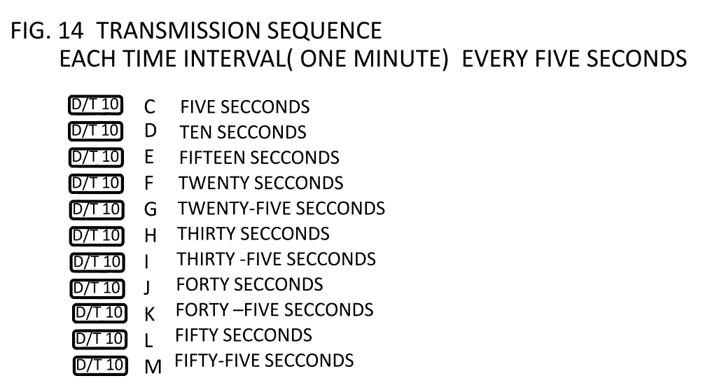

FIG. 14 is an illustration depicting the sequencing of transmissions from the devices D/T 10 of FIG. 13. In the example depicted, each detector/transmitter 10, labeled C through M would broadcast in a given time slot spaced five seconds apart. Accordingly, in one methodology a motorist would hear the individual broadcast as a continuous transmission on the motorist' radio. As described early, each individual transmission may be made from the location of the detector transmitter unit 10. Alternately, both directions in the roadway may be broadcasted as shown in the lower portion of the FIG. 13.

As used herein the geographical orientation means the vehicle orientation in terms of traveling north, east, west or south or combinations thereof.

As used herein the terminology “processor” or “controller” as used herein may be a microprocessor, computer, programmable controller, programmable chip, multiprocessor, personal computer, CPU, coprocessor, central processor, or the like.

As used herein the terminology “external” means external to the vehicle.

Embodiments of the present invention are described herein are schematic illustrations of idealized embodiments of the present invention. As such, variations from the shapes of the illustrations as a result, for example, of manufacturing techniques and/or tolerances, are to be expected. The embodiments of the present invention should not be construed as limited to the particular shapes of displays illustrated herein but are to include deviations in shapes that result, for example, from manufacturing. The regions (or display areas) illustrated in the figures are schematic in nature and their shapes are not intended to illustrate the precise shape of a region and are not intended to limit the scope of the present invention.

Although a few exemplary embodiments of the present invention have been shown and described, it would be appreciated by those skilled in the art that changes may be made in these embodiments, without departing from the principles and spirit of the invention, the scope of which is defined in the claims and their equivalents.

1. A system for monitoring the flow of vehicular traffic comprising:
at least one first transmitter receiver that detects the passage of a vehicle along a roadway fixedly positioned at a predetermined point adjacent the roadway; and
at least one fixedly positioned second transmitter for transmitting the data relating to the passage of a vehicle at a predetermined point on a roadway for use by motorists in determining a route of travel.

2. The system of claim 1 wherein the at least one first transmitter receiver comprises two first transmitter/receivers which detect the speed of a passing vehicle by measuring the time taken by the vehicle to pass between the two first transmitter/receivers, the vehicle being detected by the blockage of light beams transmitted by the two first transmitter/receivers.

3. The system of claim 1 wherein the at least one first transmitter receivers comprise radar transmitter/receivers which are spaced apart at intervals along a highway or roadway every mile or within each section of a limited access highway so that motorists may exit the limited access highway based upon the information relayed at an exit preceding the point in the limited access highway and wherein the information obtained by the radar transmitter/receivers is relayed to motorists navigating in the nearby region.

4. The system of claim 1 wherein the at least one second transmitter is operatively connected to a GPS receiver and wherein the data relating to the passage of a vehicle is used to determine average traffic speed on a predetermined route and wherein the GPS receiver determines the suggested route for navigation based upon the average traffic speeds at the recorded points on a roadway or roadways.

5. The system of claim 2 wherein the at least one second transmitter transmits at a radio frequency for reception by a motorist in the vicinity of the second transmitter, and wherein the signal strength of the radio transmission is selected to be localized so that reception is limited to motorists traveling in the local region.

6. The system of claim 2 wherein the at least one second transmitter is operatively connected to a display for displaying traffic speeds at points along a roadway.

7. The system of claim 2 further comprising a first processor, the at least one first transmitter receivers being operatively connected to the first processor, the first processor operating to determine an average speed for vehicles at a predetermined point in the roadway.

8. The system of claim 7 wherein the first processor is operatively associated with the second transmitter and wherein the second transmitter transmits average speed data to one of a GPS device, a radio broadcaster system, or a display for vehicles positioned along the same highway at a position prior to the predetermined point so that a vehicle approaching the predetermined point on the given roadway will have an option to take an alternate route depending upon the data reported.

9. The system of claim 7 wherein the second transmitter transmits to a second receiver which is located at a point remote from the predetermined point and wherein the second receiver is operatively connected to a second processor which determines average traffic speed at intervals along a roadway, the second processor being operatively connected to one of a GPS system, radio transmission, or display in the vicinity of the roadway having the predetermined point thereon.

10. A method for monitoring the flow of vehicular traffic for purposes of determining a route of travel for motorists comprising:
determining traffic speed at at least one point along a roadway using at least one first transmitter receiver fixedly positioned along a roadway that detects the passage of a vehicle; and
transmitting the traffic speed using at least one second transmitter for use by motorists in determining whether or not to select passage along the roadway containing the at least one point as a way to navigate through the region.

11. The method of claim 10 wherein the at least one first transmitter receiver comprises two first transmitter/receivers which detect the speed of a passing vehicle by measuring the time taken by the vehicle to pass between the two first transmitter/receivers, the vehicle being detected by the blockage of light beams transmitted by the two first transmitter/receivers.

12. The method of claim 10 wherein the at least one first transmitter receiver comprises a plurality of radar transmitter/receivers and wherein the radar transmitter/receivers are spaced apart at intervals exceeding five hundred feet so as to monitor the traffic on a roadway and wherein the information obtained by the radar transmitter/receivers is relayed to motorists navigating in the nearby region.

13. The method of claim 11 wherein the at least one second transmitter is operatively connected to a GPS receiver and wherein the data relating to the passage of a vehicle is used to determine average traffic speed on a predetermined route and wherein the GPS receiver determines the suggested route for navigation based upon the average traffic speeds at the recorded points on a roadway or roadways.

14. The method of claim 10 wherein the at least one second transmitter transmits at a radio frequency for reception by a motorist in the vicinity of the second transmitter, and wherein the signal strength of the radio transmission is selected to be localized so that reception is limited to motorists traveling in the local region.

15. The method of claim 11 wherein the at least one second transmitter is operatively connected to a display for displaying traffic speeds at points along a roadway.

16. The method of claim 11 further comprising a first processor, the at least one first transmitter receivers being operatively connected to the first processor, the first processor operating to determine an average speed for vehicles at a predetermined point in the roadway.

17. The method of claim 16 wherein the first processor is operatively associated with the second transmitter and wherein the second transmitter transmits average speed data to one of a GPS device, a radio broadcaster system, or a display for vehicles positioned along the same highway at a position prior to the predetermined point so that a vehicle approaching the predetermined point on the given roadway will have an option to take an alternate route depending upon the data reported.

18. The method of claim 11 wherein the second transmitter transmits to a second receiver which is located at a point remote from the predetermined point and wherein the second receiver is operatively connected to a second processor which determines average traffic speed at intervals along a roadway, the second processor being operatively connected to one of a GPS system, radio transmission, or display in the vicinity of the roadway having the predetermined point thereon.

19. A system for relaying information concerning flow of vehicular traffic along a roadway for use by persons traveling the roadway comprising:
at least one first transmitter receiver that detects the passage of a vehicle_along a roadway fixedly positioned at a predetermined point adjacent the roadway;
at least one second transmitter for transmitting the data relating to the passage of a vehicle at a predetermined point on a roadway for use by motorists in determining a route of travel.

20. The system of claim 19 further comprising at least two first transmitter receivers spaced apart a predetermined distance comprising photodetectors which detect the passage of a motor vehicle and further comprising at least one processor which determines the speed of the vehicle by determining the time the vehicle takes to travel the predetermined distance and further including recording apparatus for recording information on one of accidents, obstructions, construction work or hazards for transmission to motorists operating along the roadway at a point prior to the section of the roadway that the recorded information concerns.
